(19) United States
(12) Patent Application Publication
(10) Pub. No.: US 2014/0329050 A1
(43) Pub. Date: Nov. 6, 2014

(54) OPTOELECTRONIC DEVICES AND METHODS OF FABRICATING SAME

(71) Applicant: The Trustees of Columbia University in the City of New York, New York, NY (US)

(72) Inventors: Tingyi Gu, Hangzhou (CN); Chee Wei Wong, Singapore (SG)

(21) Appl. No.: 14/334,431

(22) Filed: Jul. 17, 2014

Related U.S. Application Data
(63) Continuation of application No. PCT/US13/20841, filed on Jan. 9, 2013.
(60) Provisional application No. 61/588,110, filed on Jan. 18, 2012.

(51) Int. Cl. G02B 1/00

(52) U.S. Cl. CPC G02B 1/005
USPC 428/135; 428/138; 428/137; 428/166; 428/172; 216/24

(57) ABSTRACT

A hybrid graphene-silicon optical cavity for chip-scale optoelectronics having attributes including resonant optical bistability for photonic logic gates and memories at femtojoule level switching per bit, temporal regenerative oscillations for self-pulsation generation at record femtojoule cavity circulating powers, and graphene-cavity enhanced four-wave mixing at femtojoule energies on the chip.

### CROSS-REFERENCE TO RELATED APPLICATIONS

This application is a continuation of International Application No. PCT/US13/20841, filed Jan. 9, 2013, which claims the benefit of U.S. Provisional Application No. 61/588,110, filed Jan. 18, 2012, the entire contents of which are hereby incorporated by reference.

### STATEMENT REGARDING FEDERALLY SPONSORED RESEARCH

This invention was made with government support under grant number DGE1069240 awarded by the National Science Foundation and grant number DE-SC0001085 awarded by the U.S. Department of Energy. The government has certain rights in the invention.

### FIELD OF THE DISCLOSED SUBJECT MATTER

The embodiments of the disclosed subject matter relate to optoelectronic devices. More particularly, the embodiments of the subject matter relate to graphene-clad photonic crystals and methods of fabrication thereof.

### BACKGROUND

The unique linear and massless band structure of graphene, in a purely two-dimensional Dirac fermionic structure, has led to intense research spanning from condensed matter physics to nanoscale device applications covering the electrical, thermal, mechanical and optical domains.

Sub-wavelength nanostructures in monolithic material platforms have witnessed rapid advances towards chip-scale optoelectronic modulators, photoreceivers, and high-bitrate signal processing architectures. Coupled with ultrafast nonlinearities as a new parameter space for optical physics, breakthroughs such as resonant four-wave mixing and parametric femtosecond pulse characterization have been described. Recently, graphene—with its broadband dispersionless nature and large carrier mobility—has been examined for its gate-variable optical transitions towards broadband ultrafast electroabsorption modulators and photoreceivers, as well as saturable absorption for mode-locking. Due to its linear band structure allowing interband optical transitions at all photon energies, graphene has been suggested as a material with large χ⁽³⁾ nonlinearities.

There remains a need for a photonic crystal with improved optical characteristics and higher energy efficiency. In particular, low-power bistability, regenerative oscillation, a high Kerr coefficient, and efficient four-wave mixing are desirable in optical telecommunications and other optical signal processing applications.

### BRIEF SUMMARY

In one aspect of the disclosed subject matter a photonic crystal is provided. In one embodiment, the photonic crystal comprises a body having opposing top and bottom surfaces and formed from at least a silicon material. In some embodiments, the top and bottom surfaces are substantially parallel to each other. The body includes a plurality of cavities defining a plurality of openings extending at least partially through the opposing top and bottom surfaces. In some embodiments, at least some of the cavities define an opening through both the top and bottom surfaces of the crystal body. Graphene is disposed on at least the top surface of the body. In some embodiments, only a monolayer is disposed on the crystal body. In some embodiments, the monolayer is substantially optically transparent to infrared.

In some embodiments, the defined openings are substantially cylindrical in shape. IN some embodiments, the plurality of cavities defines openings having a radius between about 122 nm and about 126 nm. According to various embodiments, the plurality of cavities are arranged in a variety of patterns. For example, in one embodiment, the cavities define a hexagonal pattern. In some embodiments, the pattern comprises one or more discontinuity. In some embodiments, a lattice constant of the plurality of cavities is about 420 nm. In some embodiments, the distance between the opposing top and bottom surfaces is about 250 nm.

Various embodiments of the graphene-clad photonic crystal described and embodied herein exhibit (1) ultralow power resonant optical bistability; (2) self-induced regenerative oscillations; and (3) ultrafast coherent four-wave mixing, all at a few femtojoule cavity recirculating energies. Without being held to any theory, these attributes are believed to be due to the dramatically-large and ultrafast χ⁽³⁾ nonlinearities in graphene and the large Q/V ratios in wavelength-localized photonic crystal cavities. The hybrid two-dimensional graphene-silicon nanophotonic devices according to one aspect of the present disclosure are particularly well-suited for next-generation chip-scale ultrafast optical communications, radio-frequency optoelectronics, and all-optical signal processing.

In yet another aspect, a method of fabricating a photonic crystal is provided. The method comprises providing a foil, removing a top layer of the foil, depositing carbon on the foil to form a graphene layer, coating the graphene layer with a polymer, removing the graphene layer from the foil, transferring the graphene layer onto a silicon body, and removing the polymer coating. In some embodiments, the method further comprises defining a plurality of cavities in the silicon body by various techniques known in the art. For example, suitable techniques include deep-ultraviolet lithography.

It is to be understood that both the foregoing general description and the following detailed description are exemplary and are intended to provide further explanation of the disclosed subject matter claimed.

### BRIEF DESCRIPTION OF THE FIGURES

FIGS. 1A-1D depict graphene-clad silicon photonic crystal nanostructures according to an embodiment of the present subject matter.

FIGS. 2A-2B depict bistable switching in graphene-clad nanocavities according to an embodiment of the present subject matter.

FIGS. 3A-3D depict regenerative oscillations in graphene-clad nanocavities according to an embodiment of the present subject matter.

FIGS. 4A-4D depict parametric four-wave mixing in graphene-clad silicon nanocavities according to an embodiment of the present subject matter.

FIGS. 5A-5D depict Raman spectrum and transferred graphene samples according to an embodiment of the present subject matter.

FIG. 6 depicts a comparison of switching energy versus recovery time of cavity-based modulators and switches across different semiconductor material platforms.

FIGS. 7A-7D depict steady-state two-photon absorption induced thermal nonlinearities in graphene-silicon hybrid cavities according to an embodiment of the present subject matter.

FIG. 8A-8B depict coupled-mode equations calculated self-induced optical regenerative oscillations with a silicon photonic crystal L3 nanocavity side-coupled to a photonic crystal waveguide according to an embodiment of the present subject matter.

FIG. 9 depicts free-carrier absorption effects on the four-wave mixing conversion efficiency according to an embodiment of the present subject matter.

### DETAILED DESCRIPTION

Generally, the disclosed subject matter provides a graphene-clad photonic crystal that exhibits beneficial optical properties, and a method of fabrication thereof. The graphene-clad photonic crystal can provide ultralow power optical bistable switching, self-induced regenerative oscillations, and ultrafast coherent four-wave mixing at femtojoule cavity energies on the semiconductor chip platform. Thus the disclosed subject matter is particularly well-suited for various applications including next-generation chip-scale ultrafast optical communications, radio-frequency optoelectronics and optical signal processing.

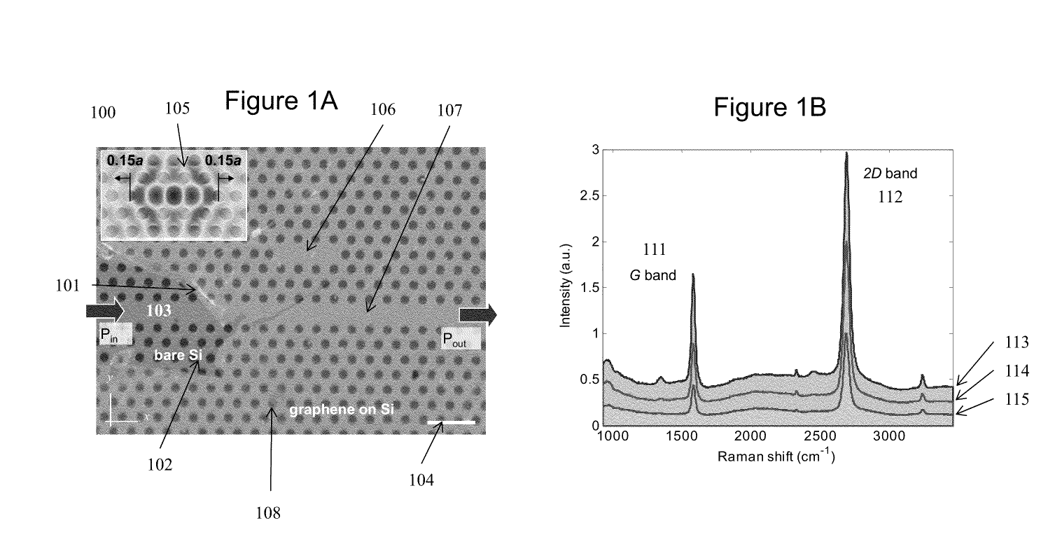

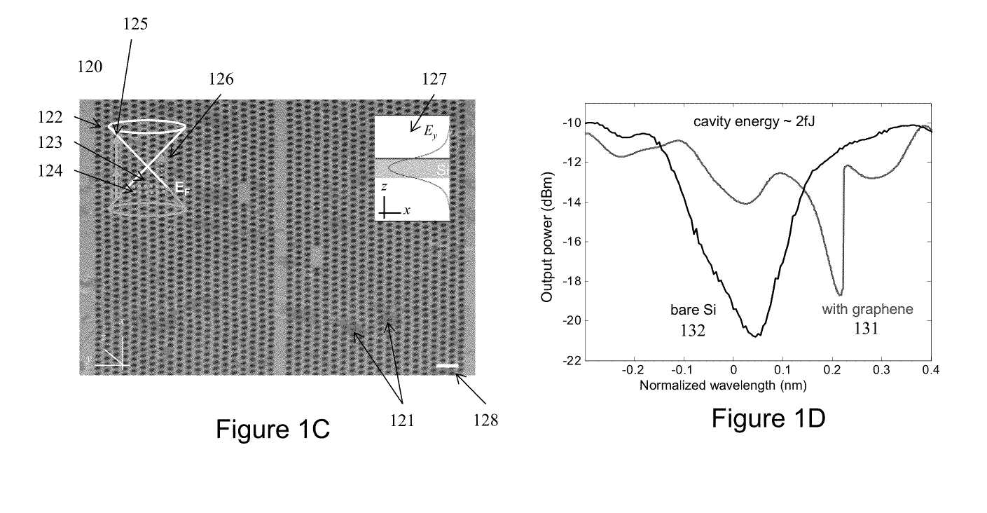

In one embodiment, as shown in FIG. 1A, the photonic crystal 100 comprises a body 102 having opposing top and bottom surfaces, the body formed from at least a silicon material. The top and bottom surfaces of body 102 can be parallel or substantially parallel to each other. The body includes a plurality of cavities 108 defining a plurality of openings extending at least partially through the opposing top and/or bottom surfaces. At least some of the cavities 108 can define an opening through both the top and bottom surfaces of the crystal body 102, and in some embodiments each of the plurality of cavities define an opening through both top and bottom surfaces. Graphene 101 is disposed on at least the top surface of the body 102. Accordingly, the structure according to this embodiment can include hybrid graphene-silicon cavities that can be achieved by rigorous transfer of a monolayer large-area graphene sheet onto an air-bridged silicon photonic crystal nanomembrane with minimal linear absorption and optimized optical input/output coupling. This structure can be complemented with large-area graphene field-effect transistors and analog circuit designs for potential large-scale silicon integration.

The graphene-clad photonic crystal nanomembranes 100 can include an optical nanocavity 106; a point-defect photonic crystal L3 cavity (with three missing holes), with nearest holes at the cavity edges tuned by 0.15a where a is the photonic crystal lattice constant. Lattice constant a can be for example 420 nm. The L3 cavity is side coupled to a photonic crystal line defect waveguide 107 for optical transmission measurements. In some embodiments, chemical vapor deposition (CVD) grown graphene can be wet-transferred onto the silicon nanomembrane with the graphene heavily p-doped, on a large sheet without requiring precise alignment.

As illustrated in FIG. 1A, the graphene can be a monolayer 101 that covers silicon body 102. A bare silicon region 103 is depicted showing the graphene monolayer 101 separated from the silicon 102 body and is provided only for illustration purposes. A scale bar 104 of 500 nm is provided for illustration. Inset 105 provides an example Ez-field from finite-difference time-domain computations.

Referring to FIG. 1B, measured Raman scattering spectra of monolayer CVD-grown graphene on a photonic crystal cavity membrane is shown. The Lorentzian lineshape full-width half-maximum of the G band 111 (34.9 cm⁻¹) and 2D band 112 (49.6 cm⁻¹) peaks and the G-to-2D peak ratio indicates the graphene monolayer, while the single symmetric G peak 111 indicates good graphene uniformity. Homogeneity across the sample is shown by exciting at different locations on the cavity membrane (curves 113, 114, and 115). The single layer graphene 101 is identified by Raman spectroscopy via the full-width half-maximum of the G (111) and 2D (112) band peaks (34.9 cm⁻¹ and 49.6 cm⁻¹ respectively) and the G-to-2D peak intensity ratio of ˜1 to 1.5. The G band lineshape 111 is a single and symmetrical Lorentzian indicating good uniformity graphene. Heavily doped graphene is prepared to achieve optical transparency in the infrared with negligible linear losses, as the Fermi level is below the one-photon interband optical transition threshold (FIG. 1C inset 125) and intraband graphene absorption is near-absent in the infrared.

Referring to FIG. 1C a SEM 120 of suspended graphene-silicon membrane is provided. Dark patches 121 denote bilayer graphene. The left inset 122 provides a Dirac cone 123 illustrating the highly-doped Fermi level (dashed circle 124) allowing only two-photon transition (solid arrows 125) while the one-photon transition (dashed arrow 126) is forbidden. The right inset 127 provides a computed Ey-field along the z-direction, with graphene at the evanescent top interface. The scale bar 128 at lower right is 500 nm.

FIG. 1D depicts an example measured graphene-clad cavity transmission with asymmetric Fano-like lineshapes 131, compared to a control bare Si cavity sample with symmetric Lorentzian lineshapes 132. Both spectra are measured at 0.6 mW input power, with similar intrinsic cavity quality factors between the graphene and the control sample. The cavity transmissions are centered to the intrinsic cavity resonances at low power (less than 100 uW input power). Transverse-electric (TE) polarization laser light is launched onto the optical cavity and evanescently coupled to the monolayer graphene. As shown in FIG. 1D, the cavity transmission spectra, performed with tunable continuous-wave laser sources, shows a consistent and large resonance red-shift of 1.2 nm/mW, approximately 4× larger than that of a near-identical control cavity without graphene.

The low power “cold cavity” transmissions taken at 2.5 μW input powers depict intrinsic Qs of 22,000 and loaded Qs of 7,500, with background Fabry-Perot oscillations arising from the input/output facet coupling reflections (˜0.12 reflectivity). The high power cavity transmission is not only red-shifted to outside the cold cavity lineshape full-width base but also exhibit a Fano-like asymmetric lineshape, with good matching to coupled-mode model predictions. With the transferred monolayer graphene onto only the short photonic crystal regions the total fiber-chip-fiber transmission is decreased by less than 1 dB, slightly better than the 5-dB additional loss in modified graphene-fiber linear polarizers (with different cavity or propagation lengths and evanescent core coupling). For the same increased cavity power on a monolithic silicon cavity without graphene, both control experiments and numerical models show a negligible thermal red-shift of 0.1 nm/mW, for the power levels and the specific loaded cavity Q²/V values [of 4.3×10⁷(λ/n)³] described herein.

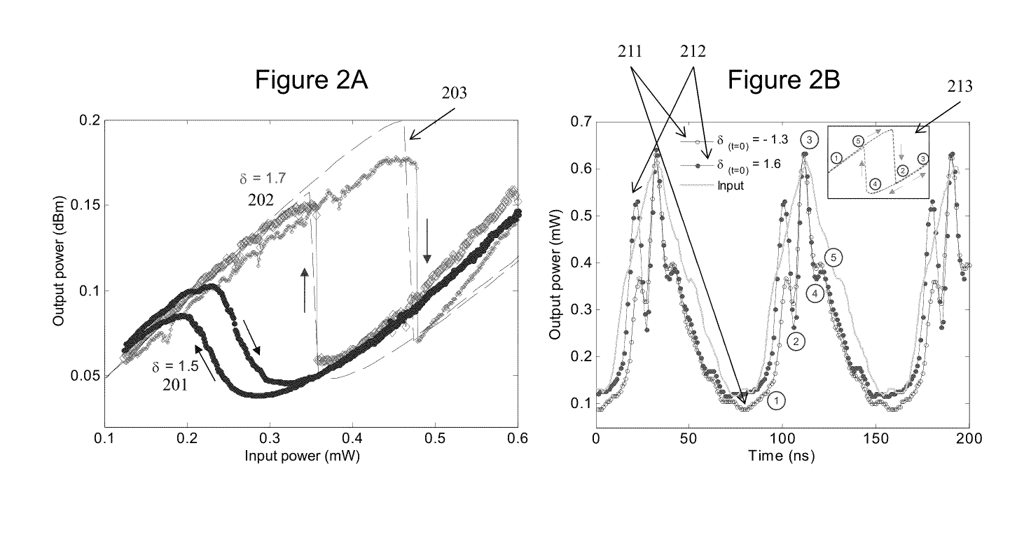

Referring to FIG. 2A steady-state input/output optical bistability for the quasi-TE cavity mode with laser-cavity detuning δ at 1.5 (201) and 1.7 (202) is depicted. The dashed line 203 is the coupled-mode theory simulation with effective nonlinear parameters of the graphene-silicon cavity sample. The large frequency shifts from the graphene-clad hybrid photonic cavity exhibit low-threshold optical bistability. FIG. 2A shows the observed bistability at 100 μW threshold powers for a loaded cavity Q of 7,500, with cavity—input laser detuning δ of 1.5 with δ defined as (λₗₐₛₑᵣ−λX_{cavity})/Δλ_{cavity}, where Δλ_{cavity} is the cold cavity full-width half-maximum linewidth. The steady-state bistable hystersis at a detuning of 1.7 is also illustrated in FIG. 2A. The dashed line 203 shows the coupled-mode theory numerical predictions of the hybrid cavity, including first-order estimates of the graphene-modified thermal, linear and nonlinear loss, and free carrier parameters (detailed below). The heavily-doped graphene has a two-photon absorption at least several times larger than silicon, described by its isotropic bands for interband optical transitions, leading to increased free carrier densities/absorption and overall enhanced thermal red-shift.

FIG. 2B depicts switching dynamics with triangular waveform drive input. The bistable resonances are shown for both positive and negative detuning Empty circles signify δ(t=0)=−1.3 (211), while solid circles signify δ(t=0)=1.6 (212). The inset (213) contains a schematic of high-and low-state transmissions. Bistable switching dynamics can be verified by inputting time-varying laser intensities to the graphene-clad cavity, allowing a combined cavity power—detuning sweep. Thus, FIG. 2B shows an example time-domain output transmission for two different initial detunings [δ₍ₜ₌₀₎=−1.3 (211) and δ₍ₜ₌₀₎=1.6 (212)] and for an illustrative triangular-waveform drive, with nanosecond resolution on an amplified photoreceiver. With the drive period at 77 ns, the observed thermal relaxation time is ˜20 ns. Cavity resonance dips (with modulation depths ˜3-dB in this example) are observed for both positive detuning (up to 0.07 nm, δ=0.58) and negative detuning (in the range from −0.15 nm (δ=0.75) to −0.10 nm (δ=0.5).

The respective bistable high- and low-state transmissions are illustrated in the inset 213 of FIG. 2B, for each bistability switching cycle. Bistability with both detunings are observable—with the negative detuning, the carrier-induced (Drude) blue-shifted dispersion overshoots the cavity resonance from the drive frequency and then thermally pins the cavity resonance to the laser drive frequency (see below). Since the free carrier lifetime of the hybrid media is about 200 ps and significantly lower than the drive pulse duration, these series of measurements are thermally dominated; the clear (attenuated) resonance dips on the intensity up-sweeps (down-sweeps) are due to the measurement sampling time shorter than the thermal relaxation timescale and a cooler (hotter) initial cavity temperature.

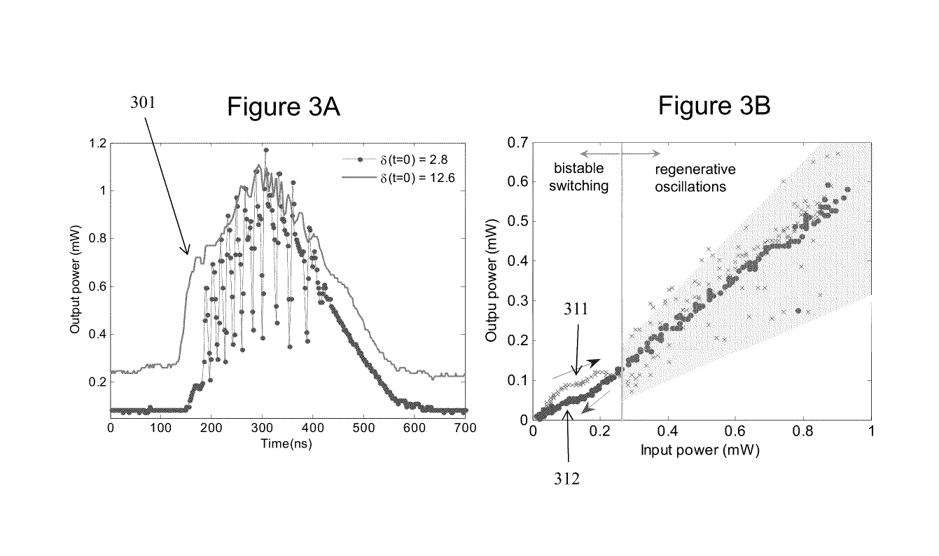

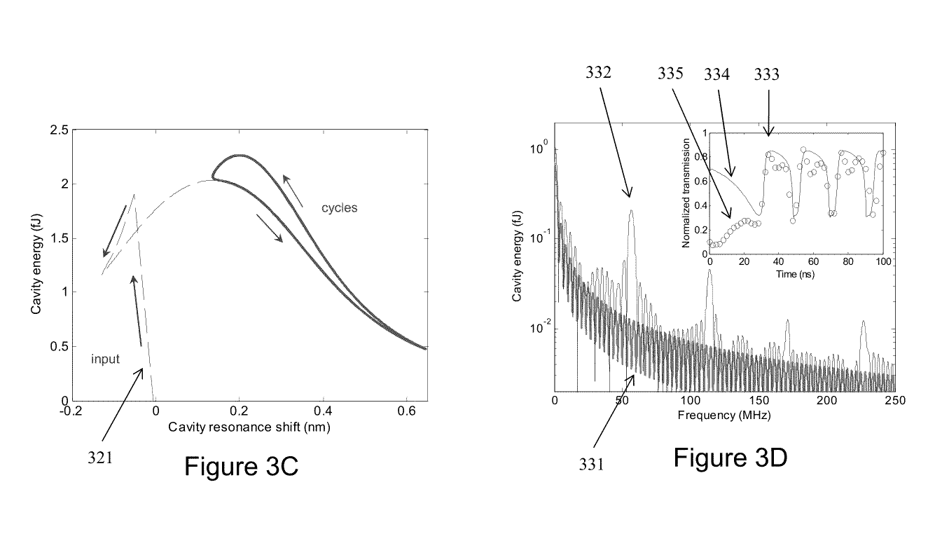

When the input laser intensity is well above the bistability threshold, the graphene-cavity system deviates from the two-state bistable switching and becomes oscillatory as shown in FIG. 3A. FIG. 3A depicts observations of temporal regenerative oscillations in the cavity for optimized detuning (0.11 nm). The input power is quasi-triangular waveform with peak power 1.2 mW. The grey line 301 is the reference output power, with the laser detuning 1.2 nm from cavity resonance. Regenerative oscillation is theoretically predicted in GaAs nanocavities with large Kerr nonlinearities or observed in high-Q (3×10⁵) silicon microdisks. These regenerative oscillations are formed between the competing phonon and free carrier populations, with slow thermal red-shifts (˜10 ns timescales) and fast free-carrier plasma dispersion blue-shifts (˜200 ps timescales) in the case of a graphene-silicon cavity resonance according to an embodiment of the present subject matter. The self-induced oscillations across the drive laser frequency are observed at threshold cavity powers of 0.4 mW, at ˜9.4 ns periods in these series of measurements which gives ˜106 MHz modulation rates, at experimentally-optimized detunings from δ₍ₜ₌₀₎=0.68 to 1.12. For a monolithic silicon L3 cavity, such regenerative pulsation has not been previously observed nor predicted to be observable at a relatively modest Q of 7,500 (see below). The temporal coupled-mode models for a conventional silicon photonic crystal cavity predict the threshold for regenerative oscillations to be at least 20 mW (even higher than the tunable laser output discussed herein), with significant nonlinear absorption.

FIG. 3B maps the output power versus input power with slow up (crosses 311) and down (dots 312) power sweeping. In the up-sweep process, the cavity starts to oscillate when the input power is beyond 0.2 mW, but the oscillation is not observed in the down-sweep process. The input-output intensity loop constructed from the temporal response measurements of a triangular-wave modulated 1.2 mW laser with a 2 μs cycle is shown. Clear bistability behavior is seen below the carrier oscillation threshold. The system transits to the regime of self-sustained oscillations as the power coupled into the cavity is above the threshold, by tuning the laser wavelength into cavity resonance.

FIG. 3C depicts nonlinear coupled-mode theory model of cavity transmission versus resonance shift, in the regime of regenerative oscillations. With a detuning of 0.15 nm [δ₍ₜ₌₀₎=0.78] the free carrier density swings from 4.4 to 9.1×10¹⁷ per cm³ and the increased temperature circulates between 6.6 and 9.1K. The fast free-carrier response fires the excitation pulse (dashed line 321 in FIG. 3C), and the heat diffusion determines the recovery to the quiescent state. In the graphene-clad suspended silicon membrane, the heat diffusion time constant is slow enough for the cavity to catch up with the free carrier dispersion. FIG. 3D depicts the spectrum of cavity energy at below (0.2 mW, dashed line 331) and beyond oscillation threshold (0.6 mW, solid line 332) at the same detuning δ₍ₜ₌₀₎=0.78, as in FIG. 3C. Inset 333 depicts normalized transmission from model (line 334) and experimental data at the same constant power level (circles 335). The beating rate between the thermal and free carrier population is around 50 MHz, as shown in inset 333 of FIG. 3D, with the matched experimental data and coupled-mode theory simulation. The beating gives rise to peaks in the radio-frequency frequency spectra (FIG. 3D; solid line 332), which are absent when the input power is below the oscillation threshold (dashed line 331).

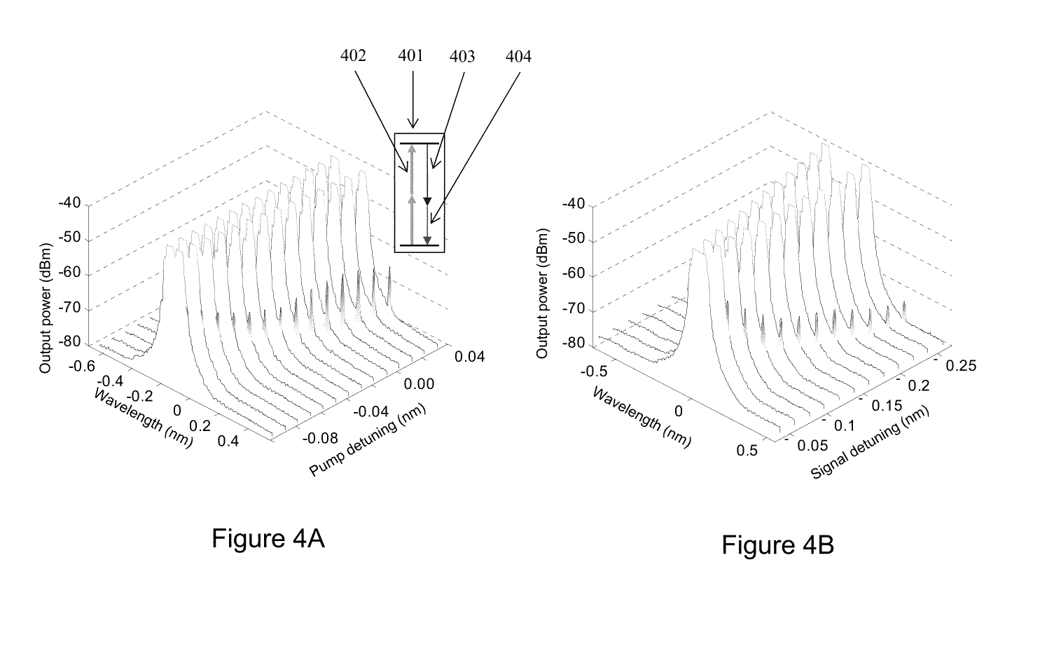

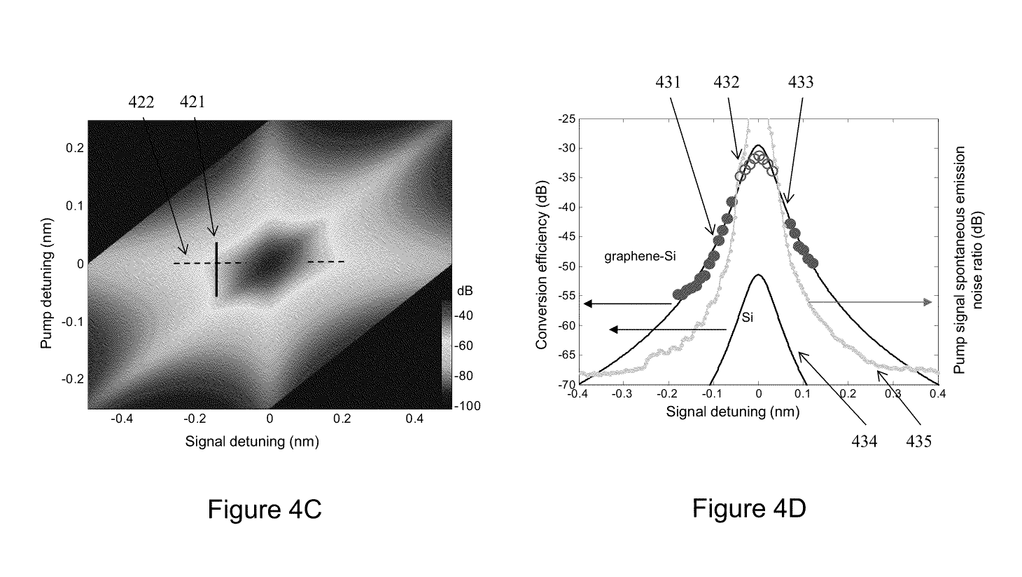

To examine only the Kerr nonlinearity, degenerate four-wave mixing measurements can be performed on the hybrid graphene-silicon photonic crystal cavities as illustrated in FIG. 4, with continuous-wave laser input. FIG. 4A depicts measured transmission spectrum with signal laser fixed at −0.16 nm according to cavity resonance, and pump laser detuning is scanned from −0.1 to 0.04 nm. The inset 401 provides a band diagram of degenerate four-wave mixing process with pump (402), signal (403) and idler (404) lasers. FIG. 4B depicts measured transmission spectrum with pump laser fixed on cavity resonance, and signal laser detuning is scanned from −0.05 to −0.25 nm.

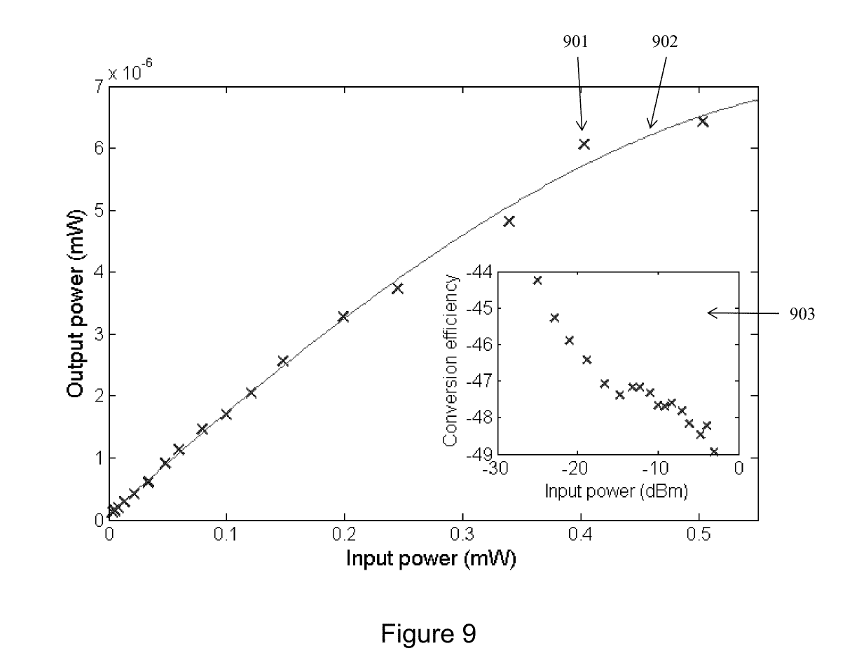

A lower-bound Q of 7,500 was chosen to allow a ˜200 pm cavity linewidth within which the highly dispersive four-wave mixing can be examined. The input pump and signal laser detunings are placed within this linewidth, with matched TE-like input polarization, and the powers set at 600 μW. Two example series of idler measurements are illustrated in FIGS. 4A and 4B, with differential pump and signal detunings respectively. In both series the parametric idler is clearly observed as a sideband to the cavity resonance, with the pump detuning ranging −100 pm to 30 pm and the signal detuning ranging from −275 pm to −40 pm, and from 70 pm to 120 pm. For each fixed signal- and pump-cavity detunings, the generated idler shows a slight intensity roll-off from linear signal (or pump) power dependence when the transmitted signal (or pump) power is greater than ˜400 μW due to increasing free-carrier absorption effects (FIG. 9 described below). As illustrated in FIGS. 4A and 4B, the converted idler wave shows a four-wave mixing 3-dB bandwidth roughly matching the cavity linewidth when the pump laser is centered at the cavity resonance.

A theoretical four-wave mixing model with cavity field enhancement (FIGS. 4C and 4D) matches with these first graphene-cavity observations, and is described in further detail below. FIG. 4C depicts modeled conversion efficiency versus pump and signal detuning from the cavity resonance. The solid lines 421 and dashed lines 422 mark the region plotted in FIGS. 4A and 4B respectively. FIG. 4D depicts observed and simulated conversion efficiency of the cavity. Solid dots 431 are measured with signal detuning as in FIG. 4B, and the empty circles 432 are obtained through pump detuning as in FIG. 4A, plus 29.5-dB (off set due to the 0.16 nm signal detuning). Solid line 433 and dashed line 434 are modeled conversion efficiencies of graphene-silicon and monolithic silicon cavities respectively. Grey dashed line 435 (superimposed) provides an illustrative pump/signal laser spontaneous emission noise ratio.

Based on the numerical model match to the experimental observations, the observed Kerr coefficient n₂ of the graphene-silicon cavity ensemble is 4.8×10⁻¹⁷ m²/W, an order of magnitude larger than in monolithic silicon and GaInP-related materials, and two orders of magnitude larger than in silicon nitride. Independently, the field-averaged effective χ⁽³⁾ and n₂ of the hybrid graphene-silicon cavity can also be modeled as described in equation (1), where E(r) is the complex fields in the cavity, n(r) is local refractive index, λ₀ is the wavelength in vacuum, and d is the number of dimensions (3).

$$\overline{{n}_{2}} = {( \frac{{λ}_{0}}{2 π} )}^{d} \frac{\int {n}^{2} ( r ) {n}_{2} ( r ) ( {\vert E ( r ) \cdot E ( r ) \vert}^{2} + 2 {\vert E ( r ) \cdot {E ( r )}^{*} \vert}^{2} ) {d}^{d} r}{{( \int {n}^{2} ( r ) {\vert E ( r ) \vert}^{2} {d}^{d} r )}^{2}} \qquad ( 1 )$$

As detailed below, the computed n₂ is at 7.7×10⁻¹⁷ m²/W, matching well with the observed four-wave mixing derived n₂. The remaining discrepancies arise from a Fermi velocity slightly smaller than the ideal values (˜10⁶ m/s) in the graphene. As illustrated in FIG. 4D for both measurement and theory, the derived conversion efficiencies are observed up to −30-dB in the unoptimized graphene-cavity, even at cavity Qs of 7,500 and low pump powers of 600 μW. The highly-doped graphene with Fermi-level level in the optical transparency region is a pre-requisite to these observations. For a monolithic silicon cavity the conversion efficiencies are dramatically lower (by more than 20-dB) as shown in dashed black line 434, and even below the pump/signal laser spontaneous emission noise ratio (dotted grey line 435) preventing four-wave mixing observation in a single monolithic silicon photonic crystal cavity till now.

### Methods of Device Fabrication

Generally, the method of device fabrication comprises the steps of providing a foil, removing a top layer of the foil, depositing carbon on the foil to form a graphene layer, coating the graphene layer with a polymer, removing the graphene layer from the foil, and transferring the graphene layer onto a silicon body, and removing the polymer coating. The method further comprises defining a plurality of cavities in the silicon body by various techniques known in the art.

In one embodiment, the photonic crystal can be defined by 248 nm deep-ultraviolet lithography in the silicon CMOS foundry onto an undoped silicon-on-insulator body. Optimized lithography and reactive ion etching can be used to produce device lattice constants of 420 nm, hole radius of 124±2 nm. The photonic crystal cavities and waveguides can be designed and fabricated on a silicon body having 250 nm thickness, followed by a buffered hydrofluoric wet-etch of the 1 um buried oxide to achieve the suspended photonic crystal nanomembranes.

For example, centimeter-scale graphene can be grown on 25 um thick copper foils by chemical vapor deposition of carbon. The top oxide layer of copper can be removed in the hydrogen atmosphere (50 mTorr, 2 sccm H₂, 1000° C. 15 min), then monolayer carbon can be formed on the copper surface (250 mTorr, 1000° C., 35 sccm CH₄, 2 sccm H₂ for 30 min). The growth is self-limited once the carbon atom covers the Cu surface catalytic. Then single layer graphene can be fast cooled down. Poly-methyl-methacrylate (PMMA) can be spun-casted onto the graphene and then the copper foil etch-removed by floating the sample in FeNO₃ solution. After the metal is removed, graphene is transferred to a water bath before subsequent transfer onto the photonic crystal membranes. Acetone can be used to dissolve the PMMA layer, and the sample rinsed with isopropyl alcohol and dry baked for the measurements.

### Optical Measurements

Continuous-wave finely-tuned semiconductor lasers from 1520 to 1620 nm (200 kHz bandwidth and −20 dBm to 7 dBm powers) can be used for optical measurements. Lensed tapered fibers (Ozoptics) with polarization controller and integrated on-chip spot size converters can be used. Without the graphene cladding (in the control sample), the total fiber-chip-fiber transmission is ˜−10 dB. The fiber to channel waveguide coupling is optimized to be 3 dB per input/output facet, with 1 to 2 dB loss from channel to photonic crystal waveguide coupling. The linear propagation loss for our air-clad photonic crystal waveguide is determined at 0.6 dB/mm; for a photonic crystal waveguide length of 0.12 mm, the propagation loss in the waveguide is negligible. The output is monitored by an amplified InGaAs photodetector (Thorlab PDA10CF, DC-150 MHz bandwidth) and oscilloscope (WaveJet 314A, 100 MHz bandwidth, 3.5 ns rise time) for the time-domain oscillations. The four-wave mixing pump laser linewidth is 10 pm (˜12 GHz). Confocal microscopy is used for the graphene Raman spectroscopic measurements with a 100× (numerical aperture at 0.95) objective, pumped with a 514 nm laser.

### Numerical Simulations

The three dimensional finite-difference-time-domain (FDTD) method with sub-pixel averaging is used to calculated the real and imaginary parts of the E-field distribution for the cavity resonant mode. The spatial resolution is set at 1/30 of the lattice constant (14 nm). Time-domain coupled mode theory including dynamic free carrier and thermal dispersion is carried out with 1 picosecond temporal resolution.

### Dynamic Conductivity and Optical Absorption of Graphene

### Estimating the Fermi Level in CVD Grown Grapheme

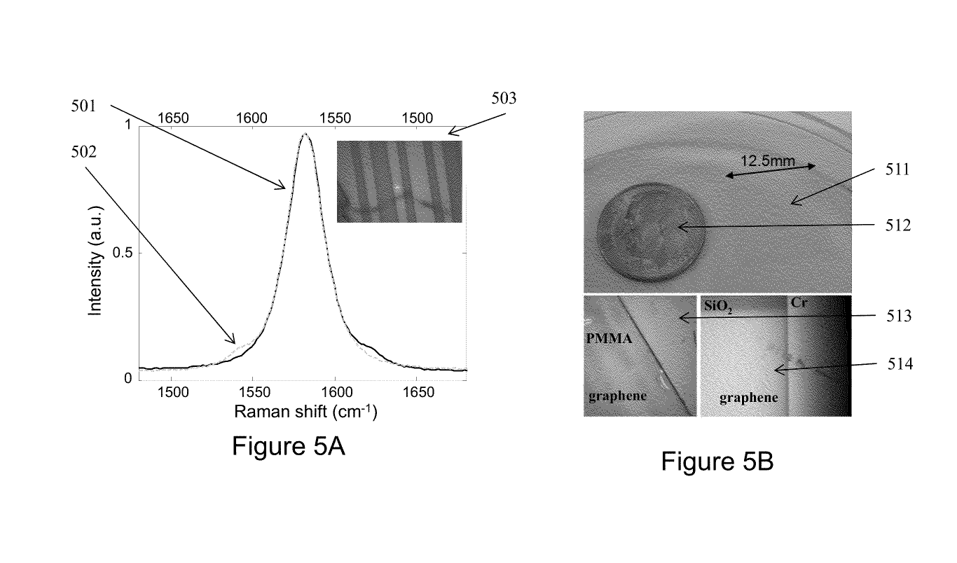

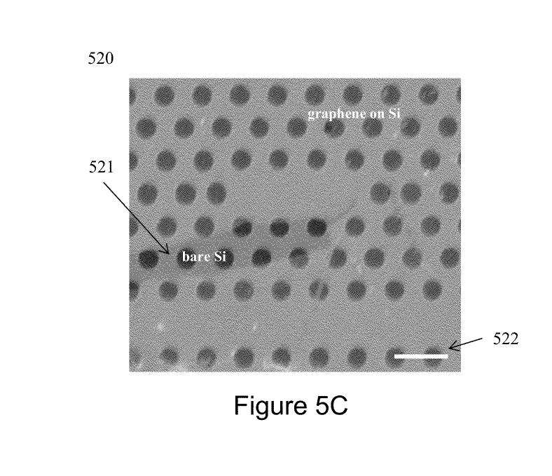

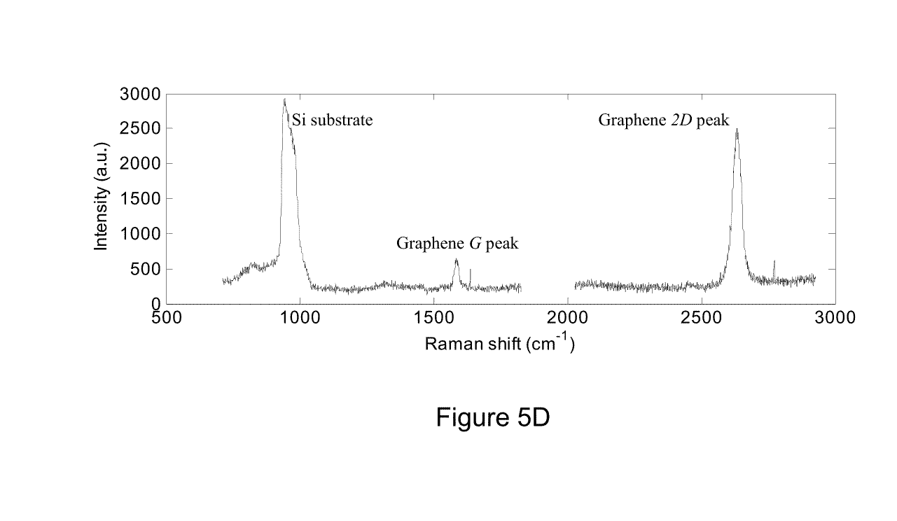

The Raman spectra are shown in FIG. 1B and FIG. 5A. The G and 2D band peaks are excited by the 514 nm green laser and are located at 1582 cm⁻¹ and 2698 cm⁻¹ respectively. The Raman spectra are homogeneous within one device, and vary less than 5 cm⁻¹ from sample to sample. The Lorenzian line-shape with full width half maximun of the G (34.9 cm⁻¹) (111) and 2D (49.6 cm⁻¹) (112) band indicates the graphene monolayer. The phonon transport properties, represented by the position of the G and 2D peaks, varying within 1 cm⁻¹ over the sample, and the intensity ratio between 2D and G peak, fluctuate from 1 to 1.5, indicating single layer and ˜5×1012 cm⁻² p doping. Good uniformity of graphene is checked by symmetrical single raman G peak 111. FIG. 5A depicts Raman G peak (black line 501) and its reverse (grey dashed line 502). The inset 503 shows an optical image of a device transferred according to an embodiment of the present subject matter. The 2D peak is observable only when the laser excitation energy (E_{L}) and the energy corresponding to electron-hole recombination process (E_{T}) follow the relation: (E_{L}−E_{T})/2>E_{F}, where E_{F} is the Fermi energy of graphene. With 514 nm laser excitation, the 2D peak is located at 2698 cm⁻¹ (FIG. 1B and FIG. 5A). Here, (EL-ET)/2=πh-×(2698 cm⁻¹)=0.17 eV, which means the Fermi level is within ±0.17 eV of the Dirac point.

FIGS. 5B and 5C illustrates example transfers of large-area CVD graphene into various substrates including poly(methyl methacrylate) [PMMA] (513), air-bridged silicon membranes, silicon oxide, and partially covered metal surfaces (514). CVD grown graphene is thicker and has rough surface compared to exfoliated graphene, shown by the broadened 2D peak and the fluctuation of the 2D versus G peak ratio. The thickness of graphene is ˜1 nm. The wrinkles on the surface are formed during the cooling down process, due to the different expansion coefficient between the copper and graphene, and typically only on the edges of samples, consistently and readily observable in the samples. At the device regions most of the devices are covered with a single unwrinkled graphene layer. FIG. 5B depicts a centimeter-scale graphene film 511 prepared in accordance with an embodiment of the present subject matter. A dime 512 is included for scale. Optical images 513 and 514 depict graphene film 511 transferred to various substrates (plastics, air-bridged silicon membranes, silicon oxide and partially covered metal surfaces), with the graphene interface pictured. FIG. 5C depicts a SEM micrograph 520 of an example air-bridged device sample in accordance with an embodiment of the present subject matter. Graphene covers the whole area except the dark (exposed) region 521. Scale bar 522 is 500 nm.

Wet transfer of graphene is used in these measurements. While a very thin (in the range of a nanometer) residual layer of PMMA typically remains on the sample after transfer, PMMA typically only has a non-centrosymmetric χ⁽²⁾ response with a neglible χ⁽³⁾ response and hence does not contribute to the enhanced four-wave mixing observations. The dopants can arise from residual absorbed molecules or ions on graphene or at the grain boundaries, during the water bath and transfer process. With the same CVD growth process, the dry transfer technique which controls the doping density is low enough such that the Fermi level is within the interband optical transition region. In that case, the measured samples have a significant increased fiber-chip-fiber coupling loss from ˜0 dB to +11 dB over the 120 μm length photonic crystal waveguide (˜0.01 dB/μm) and the resulting absorption and low pump power in the cavity prevents the various nonlinear observations as described herein. FIG. 5D depicts a Raman spectrum of the graphene-clad silicon in accordance with an embodiment of the present subject matter.

### Calculations of Graphene's Dynamic Conductivity

Given the fact that CVD graphene is heavily p-doped, the dynamic conductivity for intra- and inter-band optical transitions can be determined from the Kubo formalism according to equations (2) and (3), where e is the electron charge, h- is the reduced Plank constant, ω is the radian frequency, μ is chemical potential, and τ is the relaxation time (1.2 ps for interband, 10 fs for intraband conductivity). The dynamic conductivity of intra- and inter-band transitions at 1560 nm are (−0.07−0.90i)×10⁻⁵ and (4.15−0.95i)×10⁻⁵ respectively, leading to the total dynamic conductivity σₜₒₜₐₗ=σᵢₙₜᵣₐ+σᵢₙₜₑᵣ of (4.1−1.8i)×10⁻⁵. Given negative imaginary part of total conductivity, the TE mode is supported in graphene. The light can travel along the graphene sheet with weak damping and thus no significant loss is observed for the quasi-TE mode confined in the cavity.

$$\begin{matrix}{σ}_{intra} ( ω ) = \frac{j {e}^{2} μ}{π ℏ ( ω + j {τ}^{- 1} )} & ( 2 ) \\ {σ}_{inter} ( ω ) = \frac{j {e}^{2} μ}{4 π ℏ} ln ( \frac{2 \vert μ \vert - ℏ ( ω + j {τ}^{- 1} )}{2 \vert μ \vert + ℏ ( ω + j {τ}^{- 1} )} ) & ( 3 )\end{matrix}$$

The transferred graphene is electrically isolated from silicon by a 1 nm layer of native silicon oxide and surface roughness. The impurity density of the 250 nm thick silicon membrane is ˜10¹¹ cm⁻² (slightly lower than the doping density in graphene: ˜5×1012 cm⁻²).

### Parameter Space of Nonlinear Optics in Graphene Nanophotonics

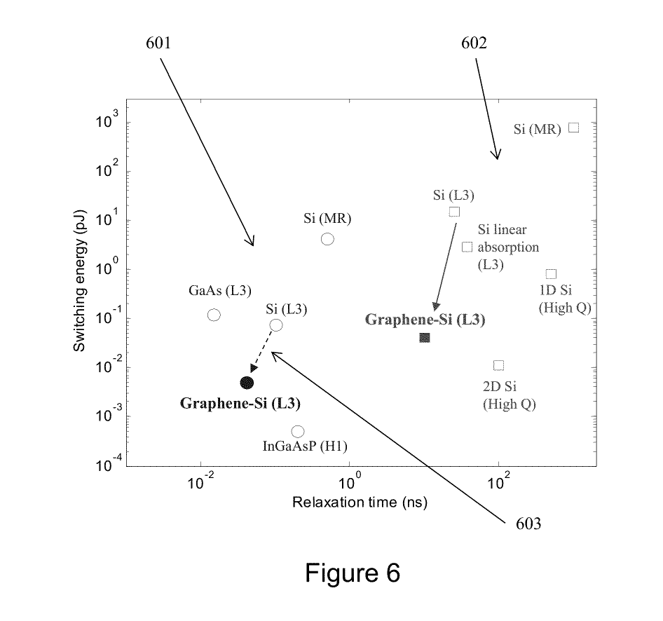

FIG. 6 depicts a comparison of switching energy versus recovery time of cavity-based modulators and switches across different semiconductor material platforms. The circles 601 are carrier plasma-induced switches with negative detuning, and the squares 602 are thermal-optic switches with positive detuning The dashed lines 603 illustrate the operating switch energies versus recovery times, for the same material. FIG. 6 compares cavity-based switching and modulation across different platforms including silicon and III-V conventional materials and the hybrid graphene-silicon cavities of the present disclosure. The thermal or free carrier plasma based switching energy is given by P_{0th/e}×τ_{th/e}, where P_{0th/e} is the threshold laser power required to shift the cavity resonance of half bandwidth through thermal/free carrier dispersion; τ_{th/e} are the thermal relax/free carrier life lifetime in resonantor. Note that the lifetime should be replaced by photon lifetime if the latter one is larger (usually for high Q cavity). Graphene brings about a lower switching energy due to strong two-photon absorption (˜3,000 cm/GW). The recovery times of thermal switching (602) are also shortened due to higher thermal conductivity in graphene, which is measured for supported graphene monolayers at 600 W/mK and bounded only by the graphene-contact interface and strong interface phonon scattering.

The switching energy is inversely proportional to two photon absorption rate (β₂). Table 1 summarizes the first-order estimated physical parameters from coupled-mode theory-experimental data matching, from full three-dimensional numerical field simulations, and from directly measured data, further detailed herein. With the enhanced two-photon absorption in graphene and first-order estimates of the reduced carrier lifetimes (detailed below), the switching energy—recovery time performance of the hybrid graphene-silicon cavity is illustrated in FIG. 5, compared to monolithic GaAs or silicon ones.

TABLE 1

| Parameter | Symbol | GaAs | Si | Graphene-Si |
|---|---|---|---|---|
| TPA coefficient | β₂ (cm/GW) | 10.2 | 1.5 | 25 [3D] |
| Kerr coefficient | n₂ (m²/W) | 1.6 × 10⁻¹⁷ | 0.44 × 10⁻¹⁷ | 7.7 × 10⁻¹⁷ [3D] |
| Thermo-optic coeff. | dn/dT | 2.48 × 10⁻⁴ | 1.86 × 10⁻⁴ | |
| Specific heat | cᵥρ (W/Km⁻³) | 1.84 × 10⁶ | 1.63 × 10⁶ [cal] | |
| Thermal relaxation time | τ_{th,c} (ns) | 8.4 | 12 | 10 [cal] |
| Thermal resistance | Rₜₕ (K/mW) | 75 | 25 | 20 [cal] |
| FCA cross section | σ (10⁻²² m³) | 51.8 | 14.5 | |
| FCD parameter | ζ (10⁻²⁸ m³) | 50 | 13.4 | |
| Carrier lifetime | τ_{fc} (ps) | 8 | 500 | 200 [CMT] |

| | | | |
|---|---|---|---|
| Loaded Q | Q | 7000 | 7000 [m] |
| Intrinsic Q | Q₀ | 30,000 | 23,000 [m] |

Table 1 provides estimated physical parameters from time-dependent coupled-mode theory-experimental matching, three-dimensional numerical field simulations, and measurement data. In the table, [CMT] signifies nonlinear time-dependent coupled mode theory simulation; [3D] signifies three-dimensional numerical field calculation averages; [m] signifies measurement at low power; and [cal] signifies first-order hybrid graphene-silicon media calculations. τ_{fc} is the effective free-carrier lifetime accounting for both recombination and diffusion.

### Graphene Two-Photon Absorption and Accompanying Thermal and Free-Carrier Nonlinearities

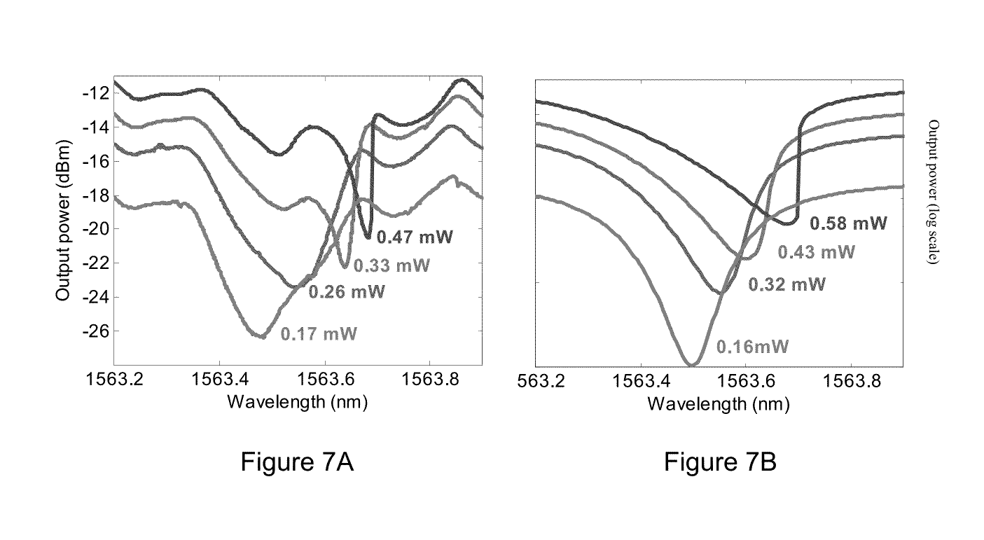

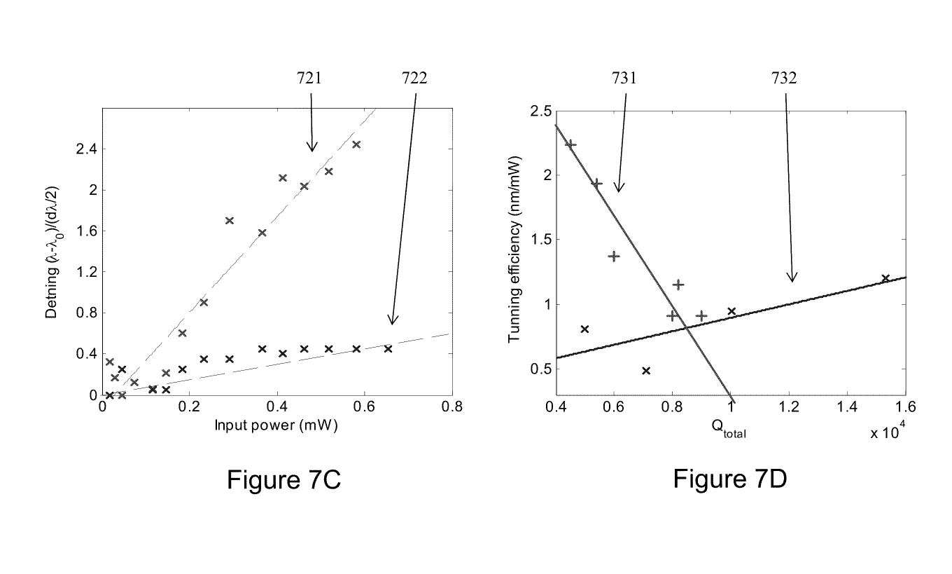

With increasing input power, the transmission spectra evolve from symmetric Lorenzian to asymmetric lineshapes as illustrated in the examples of FIG. 1d and FIG. 7. Through second-order perturbation theory, the two-photon absorption coefficient β₂ in monolayer graphene is estimated through the second-order interband transition probability rate per unit area according to equation (4), where v_{F} is the Fermi velocity, h- the reduced Planck's constant, e the electron charge, and ε_{ω} the permitivity of graphene in the given frequency. At 1550 nm wavelengths, β₂ is determined through Z-scan measurements and first-principle calculations to be in the range of ˜3,000 cm/GW.

$${β}_{2} = \frac{4 {π}^{2}}{{ɛ}_{ω} {ω}^{4} {ℏ}^{3}} {( \frac{vF {e}^{2}}{c} )}^{2} \qquad ( 4 )$$

FIG. 7A illustrates the L3 cavity resonance in the transmission spectra with different input powers. FIG. 7A depicts measured quasi-TE transmission spectra of a graphene-clad L3 cavity with different input power levels (with extracted insertion loss from the facet of waveguides in order to be comparable to simulation in FIG. 7B). FIG. 7B depicts nonlinear coupled mode theory simulated transmission spectra. The estimated input powers are marked in the panels. With thermal effects, the cavity resonance red-shifts 1.2 nm/mW for the graphene-clad sample (Q˜7,000) and only 0.3 nm/mW for silicon sample (similar Q˜7,500). These sets of measurements are summarized in FIG. 7C where the thermal red-shift is sizably larger in the graphene-clad sample versus a near-identical monolithic silicon cavity. FIG. 7C depicts measured cavity resonance shifts versus input power, with the graphene-clad cavity samples according to an embodiment of the present subject matter (721) and the monolithic silicon control cavity sample (722). In addition, FIG. 7D shows the tuning efficiency for a range of cavity Qs examined herein—with increasing Q the monoltihic silicon cavity shows an increase in tuning efficiency while the converse occurs for the graphene-silicon cavity maybe due to the complex coupling between cavity and the waveguide. FIG. 7D depicts tuning efficiencies for graphene-clad cavity samples according to an embodiment of the present subject matter (731) and control cavity samples (732) for a range of cavity loaded Q-factors examined.

The nonlinear cavity transmissions can be modeled with time domain nonlinear coupled mode theory for the dynamics of photon, carrier density and temperature according to equations (5), (6), and (7), where a is the amplitude of resonance mode; N is the free carrier density; ΔT is the cavity temperature shift. Pᵢₙ is the power carried by incident CW laser wave. κ is the coupling coefficient between waveguide and cavity, adjusted by the background Fabry-Perod resonance in waveguide. ω_{L}−ω₀ the is detuning between the laser frequency (ω_{L}) and cold cavity resonance (ω₀). The time dependent cavity resonance shift is Δω=Δω_{N}−Δω_{T}+Δω_{K}, where the free carrier dispersion is Δω_{N}=ω₀ζN/n; thermal induced dispersion is Δω_{T}=ω₀ΔT(dn/dT)/n. Δω_{K} is Kerr dispersion, and is negligibly small compared to the other two.

$$\begin{matrix}\frac{d a}{d t} ( i ( {ω}_{L} - {ω}_{0} + Δ ω ) - \frac{1}{2 {τ}_{t}} ) a + κ \sqrt{{P}_{in}} & ( 5 ) \\ \frac{d N}{d t} = \frac{1}{2 ℏ {ω}_{0} {τ}_{TPA}} \frac{{V}_{TPA}}{{V}_{FCA}^{2}} {\vert a \vert}^{4} - \frac{N}{{τ}_{fc}} & ( 6 ) \\ \frac{d Δ T}{d t} = \frac{{R}_{th}}{{τ}_{th} {τ}_{FCA}} {\vert a \vert}^{2} + \frac{Δ T}{{τ}_{th}} & ( 7 )\end{matrix}$$

The total loss rate is I/τₜ=I/τᵢₙ+I/τᵥ+I/ₗᵢₙ+I/τ_{TPA}+I/τ_{FCA}. I/τᵢₙ and I/τᵥ is the loss rates into waveguide and into freespace, (I/τ_{in/v}=ω/Q_{in/v}), the linear absorption I/τₗᵢₙ for silicon and graphene are demonstrated to be small. The free carrier absorption rate I/τ_{FCA}=cσN(t)/n. The field averaged two photon absorption rate I/τ_{TPA}= B̅₂̅c²/n²/V_{TPA}|a|², where the effective two photon absorption coeffient is defined according to equation (8) (similar to field averaged Kerr coefficient below). The mode volume for two photon absorption if given in equation (9) (same as Kerr). The effective mode volume for FCA is given in equation (10).

$$\begin{matrix}\overline{{β}_{2}} = {( \frac{{λ}_{0}}{2 π} )}^{d} \frac{\int {n}^{2} ( r ) {β}_{2} ( r ) ( {\vert E ( r ) \cdot E ( r ) \vert}^{2} + 2 {\vert E ( r ) \cdot {E ( r )}^{*} \vert}^{2} ) {d}^{d} r}{{( \int {n}^{2} ( r ) {\vert E ( r ) \vert}^{2} {d}^{d} r )}^{2}} & ( 8 ) \\ {V}_{TPA / Kerr} = \frac{{( \int {n}^{2} ( r ) {\vert A ( r ) \vert}^{2} d {r}^{3} )}^{2}}{{\int }_{Si}^{ } {n}^{4} ( r ) {\vert A ( r ) \vert}^{4} d {r}^{3}} & ( 9 ) \\ {V}_{FCA}^{2} = \frac{{( \int {n}^{2} ( r ) {\vert A ( r ) \vert}^{2} d {r}^{3} )}^{3}}{{\int }_{Si}^{ } {n}^{6} ( r ) {\vert A ( r ) \vert}^{6} d {r}^{3}} & ( 10 )\end{matrix}$$

The model shows remarkable match to the measured transmissions. With the two-photon absorption and Kerr coefficients of the hybrid cavity calculated from 3D finite-different time-main field averages and first-order estimates of the thermal properties (specific heat, effective thermal resistance and relaxation times), the carrier lifetime of the graphene-clad photonic crystal cavity is estimated to first-order at 200 ps.

### Regenerative Oscillations in Graphene-Clad Silicon Cavities

Regenerative oscillations are observed in silicon microdisks with Q at 3×10⁵ and V at 40(λ/n_{Si})³, at sub-milliwatt power levels. The graphene-enhanced two-photon absorption, free-carrier and thermal effects allow regenerative oscillations to be experimentally observable with Q²/V values [of 4.3×10⁷(λ/n)³] at least 50× lower, at the same power threshold levels. The regenerative oscillations with lower Qs allow higher speed and wider bandwidth operation, and are less stringent on the device nanofabrication.

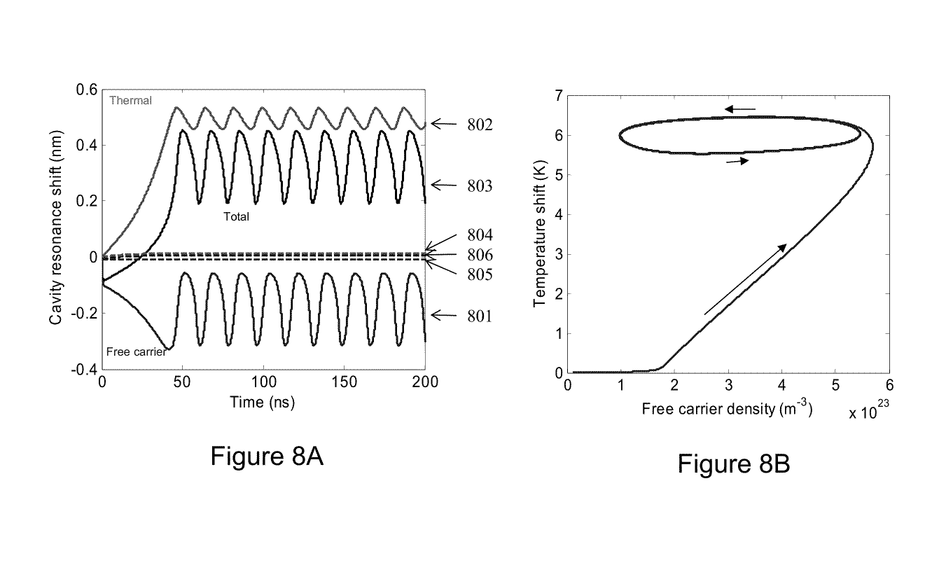

FIG. 8A depicts resonance wavelength shift, where the curve 801 and curve 802 represent the free-carrier dispersion and the thermal dispersion, respectively. Curve 803 is the net cavity resonance evolving with time. Dashed lines 804, 805, and 806 indicate the resonance shifts in silicon cavity without graphene at the same power level and detuning Dashed lines 804, 805, and 806 are correspondent to free carrier, thermal, and total resonance shift. FIG. 8B depicts cavity temperature shifts versus free carrier density.

FIGS. 8A and 8B illustrates the numerical comparison of the time-domain regeneration oscillations, with and without the graphene, on a photonic crystal L3 cavity. As shown in FIG. 8, the free carrier induced cavity resonance blue-shift is competing with the thermal induced cavity red-shift. FIG. 9 depicts free-carrier absorption effects on the four-wave mixing conversion efficiency. Measured idler power versus signal power at the transmitted port, with the pump power is fixed on the cavity resonance and the signal laser detuned by 200 pm. Experimental data is show as ×s 901 and a quadratic fit is depicted as solid line 902. Inset 903 corresponding to conversion efficiency versus signal power.

### Ultrafast Kerr in Graphene—Silicon Hybrid Structures

### Computations of Effective Kerr Nonlinearity in Graphene-Si Cavity

Third-order nonlinearity susceptibility for graphene is reported as large as |χ⁽³⁾|˜10⁻⁷ esu in the wavelength range of 760 to 840 nm. When two external beam with frequency ω₁ (pump) and ω₂ (signal) incident on graphene, the amplitude of sheet current generated at the harmonics frequencies (2ω₁−χ₂) is given in equation (11), where ε₁, ε₂ are electric field amplitude of the incident light at frequency ω₁ and ω₂ respectively. v_{F}(=10⁶ m/s) is the Fermi velocity of graphene. Under the condition that both ω₁ and ω₂ are close to ω, the sheet conductivity can be approximated according to equation (12). Since most of the sheet current is generated in graphene, the effective nonlinear susceptibility of the whole membrane can be expressed according to equation (13), where d is the thickness of the graphene (˜1 nm), λ the wavelength, and c is the speed of light in vacuum. The calculated χ⁽³⁾ is in the order of 10⁻⁷ esu (corresponding to a Kerr coefficient n₂˜10⁻¹³ m²/W), at 10⁵ times higher than in silicon (χ⁽³⁾˜10⁻¹³ esu, n₂˜4×10⁻¹⁸ m²/W).

$$\begin{matrix}{j}_{e} = - \frac{3}{32} \frac{{e}^{2}}{ℏ} {{ɛ}_{2} ( \frac{{ev}_{F} {ɛ}_{1}}{ℏ {ω}_{1} {ω}_{2}} )}^{2} \frac{2 {ω}_{1}^{2} + 2 {ω}_{1} {ω}_{2} - {ω}_{2}^{2}}{{ω}_{1} ( 2 {ω}_{1} - {ω}_{2} )} & ( 11 ) \\ {σ}^{( 3 )} = \frac{{j}_{e}}{{ɛ}_{1} {ɛ}_{1} {ɛ}_{2}} = - \frac{9}{32} \frac{{e}^{2}}{ℏ} {( \frac{{ev}_{F}}{ℏ {ω}^{2}} )}^{2} & ( 12 ) \\ {χ}^{( 3 )} = \frac{{σ}^{( 3 )}}{ω d} = - \frac{9}{32} \frac{{e}^{4} {v}_{F}^{2}}{{ℏ}^{3} {c}^{5}} \frac{{λ}^{5}}{d} & ( 13 )\end{matrix}$$

Effective n₂ of the whole membrane can be calculated for an inhomogeneous cross section weighted with respect to field distribution. With a baseline model without complex graphene-surface electronic interactions, the effective n₂ can be expressed according to equation (14), where E(r) is the complex fields in the cavity and n(r) is local refractive index. The local Kerr coefficient n₂(r) is 3.8×10⁻¹⁸ m²/W in silicon membrane and ˜10⁻¹³ m²/W for graphene, λ₀ is the wavelength in vacuum, and d=3 is the number of dimensions. The complex electric field E(r) is obtained from 3D finite-difference time-domain computations of the optical cavity examined. The resulting field-balanced effective n₂ is calculated to be 7.7×10⁻¹⁷ m²/W (λ⁽³⁾˜10⁻¹² esu). Table 2 gives the field-balanced third-order nonlinear parameters.

$$\overline{{n}_{2}} = {( \frac{{λ}_{0}}{2 π} )}^{d} \frac{\int {n}^{2} ( r ) {n}_{2} ( r ) ( {\vert E ( r ) \cdot E ( r ) \vert}^{2} + 2 {\vert E ( r ) \cdot {E ( r )}^{*} \vert}^{2} ) {d}^{d} r}{{( \int {n}^{2} ( r ) {\vert E ( r ) \vert}^{2} {d}^{d} r )}^{2}} \qquad ( 14 )$$

TABLE 2

| Computed | | |
|---|---|---|
| parameters | n̅₂̅ (m²W) | β̅₂̅ (m/W) |
| without graphene | 3.8 × 10⁻¹⁸ | 8.0 × 10⁻¹² |
| with graphene | 7.7 × 10⁻¹⁷ | 2.5 × 10⁻¹¹ |

Likewise, the effective two-photon absorption coefficient is computed in the same field-balanced approach, with a result of 2.5×10⁻¹¹ m/W. The resulting nonlinear parameter, γ=ωn₂/cA_{eff}, is derived to be 800 W⁻¹m⁻¹, from an effective mode area of 0.25 μm².

### Local Four-Wave Mixing in Graphene-Clad Photonic Crystals Cavities

The conversion efficiency of the single cavity η=|γPₚL′|²FEₚ⁴FEₛ²FE_{c}², where FEₚ, FEₛ, and FE_{c} are the field enhancement factor of pump, signal and idler respectively. The effective length L′ includes the phase mismatch and loss effects. Compared to the original cavity length (˜1582.6 nm), the effective cavity length is only slightly modified by less than 1 nm. However, the spectral dependent field enhancement factor is the square of the cavity build-up factor FE²=P_{cav}/P_{wg}=F_{cav}(U/Uₘₐₓ)ηₚ², where U/Uₘₐₓ is the normalized energy distribution with the Lorenzian lineshape. ηₚ=0.33 is the correction term for the spatial misalignment between the quasi-TE mode and graphene, and the polarization. The field enhancement effect of in cavity is proportional to the photon mode density: F_{cav}=Qλ³/(8πV).

The enhanced two-photon-absorption and induced free-carrier absorption would produce nonlinear loss. To investigate the direct effect of TPA and FCA on the four wave mixing, the conversion efficiency is measured with varying input signal power. Extra 4 dB loss is measured when the input signal power increases from −22 to −10 dBm. The major contribution is considered coming from the nonlinear loss.

It is understood that the subject matter described herein is not limited to particular embodiments described, as such may, of course, vary. Accordingly, nothing contained in the Abstract or the Summary should be understood as limiting the scope of the disclosure. It is also understood that the terminology used herein is for the purpose of describing particular embodiments only, and is not intended to be limiting. Where a range of values is provided, it is understood that each intervening value between the upper and lower limit of that range and any other stated or intervening value in that stated range, is encompassed within the disclosed subject matter.

Unless defined otherwise, all technical and scientific terms used herein have the same meaning as commonly understood by one of ordinary skill in the art to which this disclosed subject matter belongs. Although any methods and materials similar or equivalent to those described herein can also be used in the practice or testing of the present disclosed subject matter, this disclosure may specifically mention certain exemplary methods and materials.

As used herein and in the appended claims, the singular forms “a,” “an,” and “the” include plural referents unless the context clearly dictates otherwise.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosed subject matter. Various modifications can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A photonic crystal comprising:
a body formed at least from a silicon material, the body having opposing top and bottom surfaces;
a plurality of cavities disposed on the body, at least some of the cavities defining an opening extending through at least one of the top and bottom surfaces; and
a layer of graphene disposed on at least one surface of the body.

2. The photonic crystal of claim 1, wherein the graphene layer is a monolayer.

3. The photonic crystal of claim 1, wherein the graphene layer is a bilayer.

4. The photonic crystal of claim 1, wherein the body is formed from only silicon material.

5. The photonic crystal of claim 1, wherein at least some cavities define an opening extending through both the top and bottom surfaces of the body.

6. The photonic crystal of claim 1, wherein all of the cavities define an opening through both the top and bottom surfaces of the body.

7. The photonic crystal of claim 1, wherein the plurality of cavities have a shape defined by a wall of the body.

8. The photonic crystal of claim 7, wherein the shape is circular.

9. The photonic crystal of claim 7, wherein a first portion of the wall defining the cavity shape is silicon and a second portion of the wall is graphene.

10. The photonic crystal of claim 9, wherein the first portion of the wall defines a bottom layer and the second portion of the wall defines a top layer.

11. The photonic crystal of claim 1, wherein the plurality of cavities is arranged in a pattern comprising one or more discontinuities.

12. The photonic crystal of claim 9, wherein the pattern is a hexagonal pattern.

13. The photonic crystal of claim 1, wherein the plurality of cavities has a lattice constant of about 420 nm.

14. The photonic crystal of claim 1, wherein at least some of the cavities define an opening having a radius between about 122 nm and about 126 nm.

15. The photonic crystal of claim 1, wherein the body has a thickness of about 250 nm.

16. The photonic crystal of claim 1, wherein the top surface and bottom surface are substantially parallel.

17. The photonic crystal of claim 1, wherein the graphene layer is optically transparent to infrared.

18. The photonic crystal of claim 1, wherein the layer of graphene has a thickness of about 1 nanometer.

19. A photonic crystal comprising:
a silicon body having opposing top and bottom surfaces;
a layer of graphene disposed on the body; and
a plurality of cavities defining openings disposed through the top and bottom surfaces of the silicon body.

20. The photonic crystal of claim 19, wherein the plurality of cavities extend through the graphene layer.

21. The photonic crystal of claim 19, wherein the layer of graphene has a thickness of about 1 nanometer.

22. The photonic crystal of claim 19, wherein the graphene layer is transparent to infrared.

23. The photonic crystal of claim 19, wherein the silicon body has a thickness of about 250 nm.

24. The photonic crystal of claim 19, wherein at least some of the cavities define an opening having a radius between about 122 nm and about 126 nm.

25. The photonic crystal of claim 19, wherein the plurality of cavities define a hexagonal pattern.

26. The photonic crystal of claim 19, wherein the plurality of cavities has a lattice constant of about 420 nm

27. A method of fabricating a photonic crystal, said method comprising:
providing a metal foil;
removing a top oxide layer of the metal foil by exposure to a gaseous atmosphere;
depositing carbon on the metal foil to form a graphene layer;
cooling the graphene layer;
coating the graphene layer with poly(methyl methacrylate);
removing the graphene layer from the metal foil;
transferring said graphene layer onto a substrate; and
removing the poly(methyl methacrylate) coating.

28. The method of claim 27, wherein the poly(methyl methacrylate) coating is removed by exposure to acetone.

29. The method of claim 27, wherein the graphene is p-doped.

30. The method of claim 27, further comprising etching a plurality of cavities in the silicon body by deep-ultraviolet lithography.

31. The method of claim 27, wherein the gaseous atmosphere is hydrogen and further wherein the method includes exposure to 2 sccm hydrogen gas at 50 mTorr at 1000° C. for about 15 minutes.

32. The method of claim 27, wherein the metal foil is copper foil, and further wherein the graphene layer is removed from the foil by application of a FeNO₃ solution.
